(19) United States
(12) Patent Application Publication
(10) Pub. No.: US 2006/0187393 A1
(43) Pub. Date: Aug. 24, 2006

(54) LIQUID CRYSTAL PANEL AND LIQUID CRYSTAL PROJECTION DEVICE USING THEREOF

(76) Inventors: Da-Shuang Kuan, Hsinchu County (TW); Chia-Tsung Chan, Taoyuan County (TW); Tony Whitehead, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,499

(22) Filed: Feb. 23, 2005

(51) Int. Cl. G02F 1/1337; G02F 1/1335

(52) U.S. Cl. 349/130; 349/5

(57) ABSTRACT

A liquid crystal panel including first and second substrates, first and second transparent electrodes and a liquid crystal layer is provided. The first transparent electrode layer may be disposed on a surface the first substrate. The second substrate is opposite to the first substrate, and the second transparent electrode layer may be disposed on a surface of the second substrate. The liquid crystal layer including a plurality of liquid crystal molecules may be disposed between the first transparent electrode layer and the second transparent electrode layer. In addition, the first substrate and/or the second substrate may include a high temperature poly-silicon substrate, and the liquid crystal layer may include a vertical alignment nematic liquid crystal layer. In addition, a micro color filter array having a plurality of micro color filters may be disposed on another surface of the first substrate.

### BACKGROUND OF THE INVENTION

1. Field of the Invention

The present invention generally relates to a liquid crystal panel. More particularly, the present invention relates to a liquid crystal panel and a liquid crystal projection device using thereof.

2. Description of Related Art

In general, the conventional optical projector may be classified into liquid crystal display (LCD) projector, digital light processing (DLP) projector and liquid crystal on silicon (LCOS) projector according to the structure of the optical engine. Conventionally, the optical engine of DLP projector is constructed by a digital micro-mirror device (DMD) panel and a color wheel. The DMD panel is mainly for generating an image and controlling the luminance of the image. The color wheel is adopted for colorizing the image. Generally, since the optical engine of DLP projector includes only one single panel, the size and weight of DLP projector is relatively small and light.

Conventionally, the optical engine of LCD projector mainly includes LCD panel. The LCD panel may be classified into amorphous silicon LCD panel, low temperature poly-silicon (LTPS) LCD panel and high temperature poly-silicon (HTPS) LCD panel according to the manufacturing process of the LCD panel. In general, the amorphous silicon LCD panel is suitable for LCD display but not applicable for LCD projector since the resolution of the small sized amorphous silicon LCD panel is not adequate for LCD projector. In addition, the driving circuit such as thin-film transistor (TFT) for the pixel of the LCD panel may be constructed on the LTPS or HTPS LCD panel directly. Therefore, the LTPS or HTPS LCD panel is adopted for LCD projector.

FIG. 1 is a schematic view of a conventional three-panel LCD projector. Referring to FIG. 1, the conventional three-panel LCD projector 100 includes a lamp 102, a polarization conversion system (PCS) 104, reflection mirrors 106, 112, 114 and 116, a blue dichroic mirror 108, a green dichroic mirror 110, a green LCD panel 122, a red LCD panel 124, a blue LCD panel 126, an X-cube 128 and a projection lens 130. The lamp 102 provides a light 132. The light 132 may be polarized by the PCS 104 to generate a polarized light 134. The light 134 is reflected to the blue dichroic mirror 108 by the reflection mirror 106. Thereafter, the blue light 136 of the light 134 is allowed to pass through the blue dichroic mirror 108, and the other component of the light 134 is reflected to the green dichroic mirror 110. The red light 138 of the light 134 is allowed to pass through the green dichroic mirror 110, and the green light 140 of the light 134 is reflected to the green LCD panel 122. In addition, the blue light 136 and the red light 138 of the light 134 are reflected to the blue LCD panel 126 and the red LCD panel 124 by the reflection mirrors 116 and 114 respectively.

The blue, red and green lights 136, 138 and 140 pass through the blue, red and green LCD panels 126, 124 and 122, wherein the polarizations of the red and green lights 136, 138 and 140 may be changed to generate blue, red and green images respectively. The blue, red and green images are combined by the X-cube 128 and projected by the projection lens 130 to generate the projected image 142.

Generally, the conventional three-panel LCD projector may provide high luminance and colorful images compared to the other type of conventional projectors. However, referring to FIG. 1, precise alignment of the path of blue, red and green lights 136, 138 and 140 are important since the projected image 142 is generated by combining lights 136, 138 and 140. In other words, the stability of the resolution of the projected image 142 is considerably dependent on the thermal reliability of the LCD panels 126, 124 and 122 and the X-cube 128. Generally, the resolution of the projected image 142 is reduced due to the variation of the path of blue, red and green lights 136, 138 and 140 caused by the thermal deformation of LCD panels 126, 124, 122 or the X-cube 128.

In addition, the contrast ratio of the three-panel LCD projector is lower than the conventional DLP projectors since some light may leak from the LCD panels of the optical engine of the three-panel LCD projector, especially when the frame of the projected image is completely dark. Moreover, the three-panel LCD projector is heavier, larger and more complex than the other conventional DLP projectors since the optical engine of the three-panel LCD projector includes three panels and three reflection mirrors. Accordingly, a novel technology of LCD projector having high luminance, high contrast ratio, excellent resolution and being small, light, simple and low cost is highly desired.

### SUMMARY OF THE INVENTION

Accordingly, the present invention is directed to a liquid crystal panel including high temperature poly-silicon substrates and vertical alignment nematic liquid crystal layer. Therefore, the liquid crystal panel may be single-panel and may provide high luminance, high contrast ratio, high response time, high resolution and may be small, light, simple and low cost.

In addition, the present invention is directed to a liquid crystal projection device including a liquid crystal panel having high temperature poly-silicon substrates and vertical alignment nematic liquid crystal layer. Therefore, the liquid crystal panel may be a single-panel and may provide high luminance, high contrast ratio, high response time, high resolution and may be small, light, simple and low cost.

The liquid crystal panel of the present invention may comprise, for example but not limited to, first and second substrates, first and second transparent electrode layers and a liquid crystal layer. The first transparent electrode layer may be disposed on a surface of the first substrate. The second substrate is opposite to the first substrate, and the second transparent electrode layer may be disposed on a surface of the second substrate. The liquid crystal layer comprising a plurality of liquid crystal molecules may be disposed between the first transparent electrode layer and the second transparent electrode layer. In addition, the first substrate and/or the second substrate may comprise a high temperature poly-silicon substrate, and the liquid crystal layer may comprise a vertical alignment nematic liquid crystal layer.

In one embodiment of the present invention, the liquid crystal panel may further comprises a micro color filter array having a plurality of micro color filters, wherein the micro color filter array may be disposed on another surface of the first substrate. In addition, the micro color filters may comprise dichroic micro color filters. In another embodiment of the present invention, the material of the micro color filter array may comprise an inorganic material. In another embodiment of the present invention, the micro color filters may have a round shape or a rounded rectangular shape.

In one embodiment of the present invention, the liquid crystal panel may further comprises a plurality of protrusions disposed on the first transparent electrode layer and/or the second electrode layer for aligning the liquid crystal molecules.

In one embodiment of the present invention, the liquid crystal panel is a single-panel liquid crystal panel. In addition, each pixel of the single-panel liquid crystal panel may comprise a plurality of color sub-pixels.

In one embodiment of the present invention, the color sub-pixels may comprise red, green and blue pixels or may comprise red, green, blue and white pixels.

In one embodiment of the present invention, the liquid crystal panel may be suitable for a liquid crystal projection device.

The liquid crystal projection device of the present invention may comprise, for example but not limited to, a light source, a polarizer, a liquid crystal panel, an analyzer and a projection lens. The light source may be adopted for providing a light. The polarizer may be disposed on the path of the light. The liquid crystal panel may be disposed after the polarizer on the path of the light. The analyzer may be disposed after the liquid crystal panel on the path of the light. The projection lens may be disposed after the analyzer on the path of the light. In addition, the liquid crystal panel of the present invention may comprise, for example but not limited to, first and second substrates, first and second transparent electrode layers and a liquid crystal layer. The first transparent electrode layer may be disposed on a surface of the first substrate. The second substrate is opposite to the first substrate, and the second transparent electrode layer may be disposed on a surface of the second substrate. The liquid crystal layer comprising a plurality of liquid crystal molecules may be disposed between the first transparent electrode layer and the second transparent electrode layer. In addition, the first substrate and/or the second substrate may comprise a high temperature poly-silicon substrate, and the liquid crystal layer may comprise a vertical alignment nematic liquid crystal layer.

In one embodiment of the present invention, the liquid crystal panel may further comprises a micro color filter array having a plurality of micro color filters, wherein the micro color filter array may be disposed on another surface of the first substrate. In addition, the micro color filters may comprise dichroic micro color filters. In another embodiment of the present invention, the material of the micro color filter array may comprise an inorganic material. In another embodiment of the present invention, the micro color filters may have a round shape or a rounded rectangular shape.

In one embodiment of the present invention, the liquid crystal panel may further comprises a plurality of protrusions disposed on the first transparent electrode layer and/or the second electrode layer for aligning the liquid crystal molecules.

In one embodiment of the present invention, the liquid crystal panel is a single-panel liquid crystal panel. In addition, each pixel of the single-panel liquid crystal panel may comprise a plurality of color sub-pixels.

In one embodiment of the present invention, the color sub-pixels may comprise red, green and blue pixels or may comprise red, green, blue and white pixels.

In one embodiment of the present invention, the liquid crystal panel may be suitable for a liquid crystal projection device.

In one embodiment of the present invention, the liquid crystal projection device may further comprise a polarization conversion system disposed on the path of the light and between the light source and the polarizer.

In one embodiment of the present invention, the liquid crystal projection device may further comprise a lens disposed between the light source and the polarizer on the light path.

In one embodiment of the present invention, the material of the first substrate or the second substrate comprises quartz.

Accordingly, in the present invention, since the liquid crystal panel includes high temperature poly-silicon substrates, the liquid crystal panel may be single-panel and may provide high luminance, high resolution and may be small, light, simple and low cost. In addition, since the liquid crystal layer of the liquid crystal panel may be a vertical alignment nematic liquid crystal layer, the liquid crystal panel may provide high contrast ratio and high response time. In addition, since the material of the micro color filters of the present invention may comprise inorganic material, the thermal stability and the thermal endurance of the micro color filters of the present invention are excellent.

One or part or all of these and other features and advantages of the present invention will become readily apparent to those skilled in this art from the following description wherein there is shown and described one embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional three-panel LCD projector.

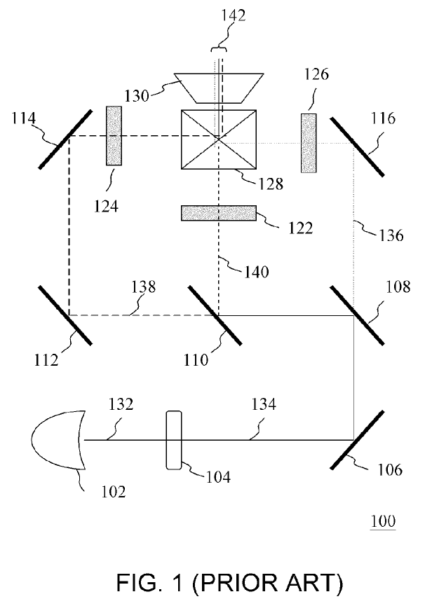

FIG. 2 is a schematic view illustrating a single-panel LCD projection device according to one embodiment of the present invention.

FIG. 3 is a schematic top view of a single-panel LCD panel according to one embodiment of the present invention.

FIG. 4A to FIG. 4C are schematic views illustrating arrangement method of sub-pixels of a single-panel LCD panel according to one embodiment of the present invention.

FIG. 5A and FIG. 5B are schematic cross-sectional views of a VAN HTPS LCD panel according to one embodiment of the present invention.

FIGS. 6A and 6B are cross-sectional views of a VAN HTPS LCD panel according to another embodiment of the present invention.

FIGS. 7A and 7B are schematic top views illustrating a shape of a micro color filter arrays on a LCD panel according to the embodiments of the present invention.

### DESCRIPTION OF EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

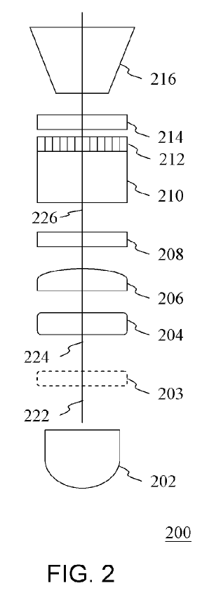

FIG. 2 is a schematic view illustrating a single-panel LCD projection device according to one embodiment of the present invention. Referring to FIG. 2, a single-panel LCD projection device 200 may comprise, for example but not limited to, a light source 202, a polarization conversion system (PCS) 204, a lens 206, a polarizer 208, a LCD panel 210, a micro color filter array 212 on the LCD panel 210, an analyzer 214 and a projection lens 216. The light source 202 may be adopted for providing a light 222. It is noted that, all the components 204, 206, 208, 210, 212, 214 and 216 are disposed on the path of the light 222. In one embodiment of the present invention, a filter 203 may be optionally disposed on the path of light 222 and between the light source 202 and the PCS 204. Therefore, the other component of the light 222 except for the visible light, such as ultraviolet, infrared or far infrared light, may be filtered out.

Referring to FIG. 2, the light 222 may be polarized by the PCS 204 to generate a polarized light 224. In addition, the polarization direction of the polarized light 224 may also be rendered uniformed by the PCS 204. Then, the polarized light 224 is focused to the polarizer 208 by the lens 206, wherein only a portion of the polarized light 224 having a certain polarization direction (i.e., light 226) may pass through the polarizer 208 and be incident to the LCD panel 210.

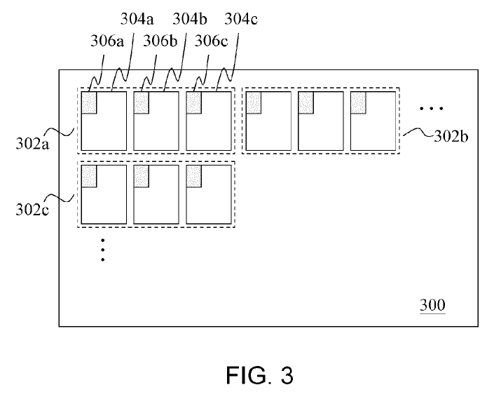

FIG. 3 is a schematic top view of a single-panel LCD panel according to one embodiment of the present invention. Referring to FIG. 3, a single-panel LCD panel 300 may comprise, for example but not limited to, a plurality of pixels 302a, 302b, 302c and etc., wherein each of the pixels, such as the pixel 302a, may comprise sub-pixels 304a, 304b and 304c. In addition, each of the sub-pixels such as the sub-pixels 304a, 304b and 304c may comprise a driving circuit such as the thin film transistors 306a, 306b and 306c respectively. In one embodiment of the present invention, the sub-pixels 304a, 304b and 304c may have three primary colors respectively. The three primary colors may comprise red, green and blue colors. It should be noted that, the number of sub-pixels are not limited to only three colors. In another embodiment of the present invention, each pixel may also comprise, for example, four sub-pixels having red, green, blue and white colors respectively.

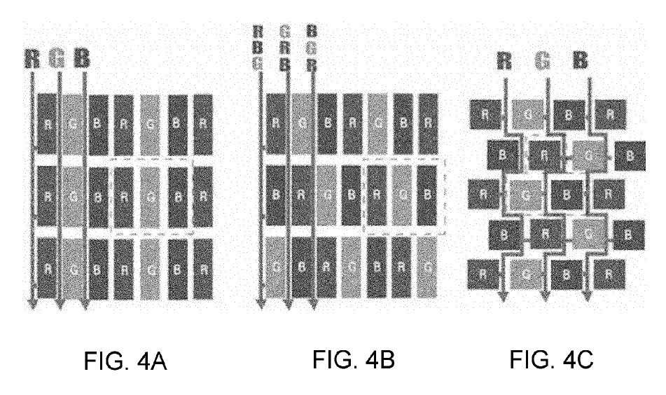

FIG. 4A to FIG. 4C are schematic views illustrating arrangement method of sub-pixels of a single-panel LCD panel according to one embodiment of the present invention. Referring to FIG. 4A, the sub-pixels of the LCD panel are arranged in strip arrangement scheme. Referring to FIG. 4B, the sub-pixels of the LCD panel are arranged in mosaic arrangement scheme. Referring to FIG. 4C, the sub-pixels of the LCD panel are arranged in delta arrangement scheme. It should be noted that, the arrangement schemes shown in FIGS. 4A to 4C are illustrated as examples and cannot be used to limit the scope of the present invention. In another words, any other suitable arrangement schemes of the sub-pixels suitable for single LCD panel may also be adopted for achieving the purpose of the present invention.

In one embodiment of the present invention, the LCD panel 210 may comprise a HTPS LCD panel. The material of the HTPS LCD panel may comprise, for example, quartz. In general, the HTPS LCD panel has faster electron mobility than the LTPS LCD panel, and thus the size of the driving circuit of the HTPS LCD panel may be much smaller. Therefore, the HTPS LCD panel may have higher aperture ratio and higher resolution, and may reduce the size of the LCD projector. In addition, the HTPS LCD panel also has a higher thermal stability and thermal endurance than the LTPS LCD panel. Accordingly, the HTPS LCD panel is applicable for single-panel LCD projector and may achieve higher resolution, higher luminance, higher thermal stability and smaller size.

In addition, the combination of the images of the three color lights of the single-panel LCD projector or the present invention are more stable than the three-panel LCD projector since all the sub-pixels are formed on the same single LCD panel.

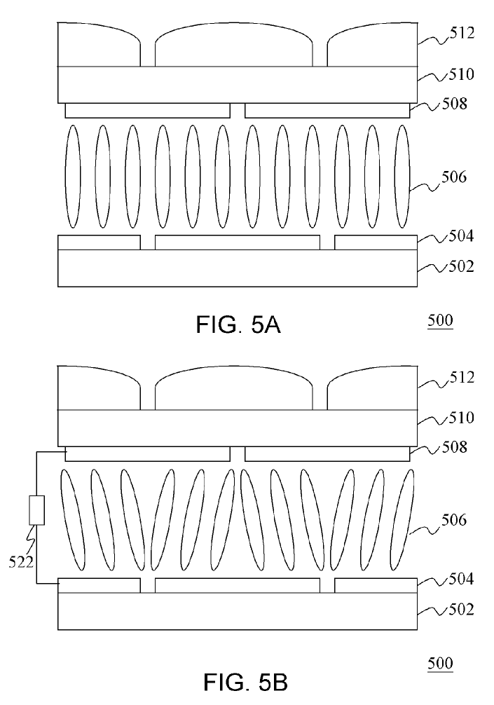

In one embodiment of the present invention, the HTPS LCD panel of the present invention may further comprise a vertical alignment nematic (VAN) HTPS LCD panel. FIGS. 5A and 5B are schematic cross-sectional views of a VAN HTPS LCD panel according to one embodiment of the present invention. Referring to FIG. 5A, a VAN HTPS LCD panel 500 may comprise, for example, a first substrate 502, a first transparent electrode layer 504, a liquid crystal layer 506 comprising a plurality of liquid crystal molecules, a second transparent electrode layer 508, a second substrate 510 and a plurality of micro color filters 512. In one embodiment of the present invention, the first substrate 502 and/or the second substrate 510 may comprise HTPS substrate. In addition, the material of the first transparent electrode layer 504 and the second transparent electrode layer 508 may comprise indium tin oxide (ITO) or indium zinc oxide (IZO). Referring to FIG. 5A, it is noted that when no voltage is being applied between the first transparent electrode layer 504 and the second transparent electrode layer 508, the long axis of the liquid crystal molecules of the liquid crystal layer 506 are substantially perpendicular to the substrate 502 or 510.

Referring to FIG. 5B, a voltage 522 is applied between the transparent electrode layers 504 and 508 of the VAN HTPS LCD panel 500. In the meanwhile, the liquid crystal molecules in the liquid crystal layer 506 are twisted and thus the polarization of the color lights transmitted through the liquid crystal layer 506 may be changed. The level of the gray scale of the light passing through the liquid crystal layer 506 may be adjusted by adjusting the level of the voltage 522 to change the direction of the liquid crystal molecules of the liquid crystal layer 506.

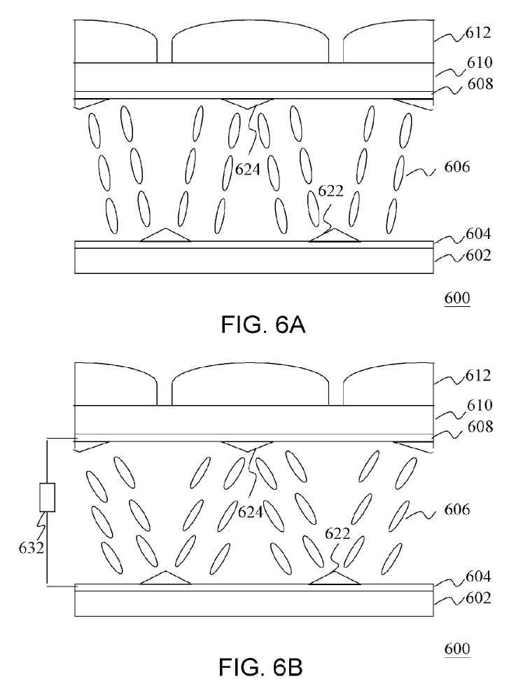

FIGS. 6A and 6B are cross-sectional views of a VAN HTPS LCD panel according to another embodiment of the present invention. Referring to FIG. 6A, a VAN HTPS LCD panel 600 may comprise, for example, a first substrate 602, a first transparent electrode layer 604, a liquid crystal layer 606 comprising a plurality of liquid crystal molecules, a second transparent electrode layer 608, a second substrate 610, a plurality of micro color filters 612, and a plurality of protrusions 622 and 624. In one embodiment of the present invention, the first substrate 602 and/or the second substrate 610 may comprise HTPS substrate. In addition, the material of the first transparent electrode layer 604 and the second transparent electrode layer 608 may comprise indium tin oxide (ITO) or indium zinc oxide (IZO). Referring to FIG. 6A, it is noted that when no voltage is applied between the first transparent electrode layer 604 and the second transparent electrode layer 608, the liquid crystal molecules of the liquid crystal layer 606 are aligned by the protrusions 622 and 624 and almost substantially perpendicular to the substrate 602 or 610.

Referring to FIG. 6B, a voltage 632 is applied between the transparent electrode layers 604 and 608 of the VAN HTPS LCD panel 600. Therefore, the liquid crystal molecules in the liquid crystal layer 606 are twisted and thus the polarization of the color lights transmitted through the liquid crystal layer 606 may be changed. The level of the gray scale of the light passing through the liquid crystal layer 606 may be adjusted by adjusting the level of the voltage 632 to change the direction of the liquid crystal layer 606.

Referring to FIGS. 5A, 5B, 6A or 6B, the micro color filters 512 or 612 are adopted for colorizing and focusing the lights passing through each sub-pixels of the LCD panel 500 or 600. In one embodiment of the present invention, the micro color filters 512 or 612 may comprise dichroic micro color filters. For example, the red, green and blue sub-pixels may comprise red, green and blue dichroic micro filters respectively. In another embodiment of the present invention, the material of the micro color filter may comprise inorganic material. Accordingly, since the micro color filter may comprise inorganic material, the micro color filter may be stable under high temperature. Therefore, the thermal stability and the thermal endurance of the micro color filter of the present invention are excellent.

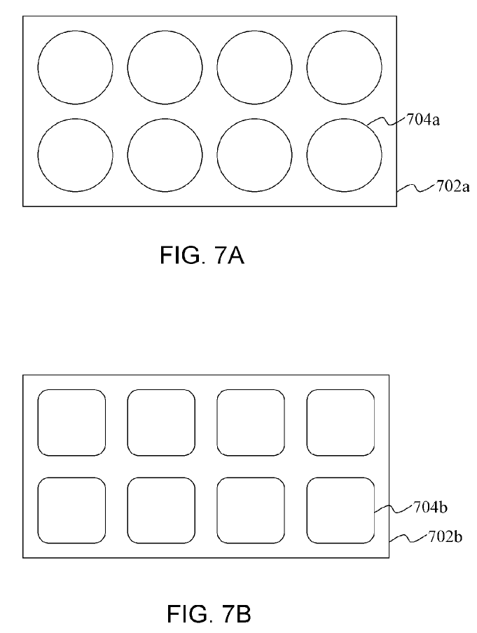

FIGS. 7A and 7B are schematic top views illustrating a shape of a micro color filter arrays on a LCD panel according to the embodiments of the present invention. Referring to FIG. 7A, the micro color filters 704a on the LCD panel 702a may have a round shape. Referring to FIG. 7B, the micro color filters 704b on the LCD panel 702b may also have a rounded rectangular shape. In one embodiment of the present invention, the micro color filters 512 or 612 as shown in FIG. 5A, 5B, 6A or 6B may have a round shape, a rounded rectangular shape or any other shape that may focus the lights. In addition, the arrangement of the color micro color filters 512 or 612 as shown in FIG. 5A, 5B, 6A or 6B or the color micro color filters 704a or 704b shown in FIG. 7A or FIG. 7B may be referred to FIGS. 4A to 4C or any other arrangement schemes.

In one embodiment of the present invention, the LCD panel 500 shown in FIG. 5A or 5B or the LCD panel 600 shown in FIG. 6A or 6B may be adopted for the LCD panel 210 and the micro color filter array 212 shown in FIG. 2. Accordingly, the LCD panel of the present invention may have high contrast ratio since the liquid crystal molecules are substantially perpendicular to the surface of the LCD panel when no voltage is applied to the LCD panel (As shown in FIG. 5A or 6A). Therefore, referring to FIG. 2, when no voltage is applied to the LCD panel (As shown in FIG. 5A or 6A), the light passing through the LCD panel 210 and the micro color filter array 212 can not pass through the analyzer 214. Thus, even though the LCD panel 210 is displaying a black frame, the light leakage through the LCD panel 210 is reduced drastically and therefore the contrast ratio of the LCD panel 200 may be enhanced. In addition, comparing FIG. 5A to FIG. 5B or FIG. 6A to FIG. 6B, the response time of the LCD panel 500 or 600 are faster than the conventional LCD panels since the liquid crystal molecules of the liquid crystal layer 506 or 606 are substantially perpendicular to the LCD panel 500 or 600 when no voltage is applied, and are only tilted with a small angle when the voltage is applied.

Accordingly, in the present invention, since the liquid crystal panel includes high temperature poly-silicon substrates, the liquid crystal panel may be single-panel and may provide high luminance, high resolution and may be small, light, simple and low cost. In addition, since the liquid crystal layer of the liquid crystal panel may be a vertical alignment nematic liquid crystal layer, the liquid crystal panel may provide high contrast ratio, high response time. In addition, since the material of the micro color filters of the present invention may comprise inorganic material, the thermal stability and the thermal endurance of the micro color filters of the present invention are excellent.

The foregoing description of the embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A liquid crystal panel, comprising:
a first substrate;
a first transparent electrode layer, disposed on a surface the first substrate;
a second substrate opposite to the first substrate;
a second transparent electrode layer, disposed on a surface of the second substrate; and
a liquid crystal layer, comprising a plurality of liquid crystal molecules and disposed between the first transparent electrode layer and the second transparent electrode layer;
wherein the first substrate and/or the second substrate comprises a high temperature poly-silicon substrate, and the liquid crystal layer comprises a vertical alignment nematic liquid crystal layer.

2. The liquid crystal panel of claim 1, further comprising:
a micro color filter array comprising a plurality of micro color filters and disposed on another surface of the first substrate.

3. The liquid crystal panel of claim 2, wherein the micro color filters comprise dichroic micro color filters.

4. The liquid crystal panel of claim 2, wherein a material of the micro color filter array comprises an inorganic material.

5. The liquid crystal panel of claim 2, wherein the micro color filters have a round shape.

6. The liquid crystal panel of claim 2, wherein the micro color filters have a rounded rectangular shape.

7. The liquid crystal panel of claim 1, further comprising:
a plurality of protrusions, disposed on the first transparent electrode layer and/or the second electrode layer for aligning the liquid crystal molecules.

8. The liquid crystal panel of claim 1, wherein the liquid crystal panel comprises a single-panel liquid crystal panel.

9. The liquid crystal panel of claim 4, wherein a pixel of the single-panel liquid crystal panel comprise a plurality of color sub-pixels.

10. The liquid crystal panel of claim 9, wherein the color sub-pixels comprise red, green and blue pixels.

11. The liquid crystal panel of claim 9, wherein the color sub-pixels comprise red, green, blue and white pixels.

12. The liquid crystal panel of claim 1, wherein the liquid crystal panel is suitable for a liquid crystal projection device.

13. A liquid crystal projection device, comprising:
a light source, for providing a light;
a polarizer, disposed on a path of the light;
a liquid crystal panel, disposed after the polarizer and on the path of the light, the liquid crystal panel comprising:
a first substrate;
a first transparent electrode layer, disposed on a surface the first substrate;
a second substrate, disposed opposite to the first substrate;
a second transparent electrode layer, disposed on a surface of the second substrate;
a liquid crystal layer, comprising a plurality of liquid crystal molecules and disposed between the first transparent electrode layer and the second transparent electrode layer;
wherein the first substrate and/or the second substrate comprises a high temperature poly-silicon substrate, and the liquid crystal layer comprises a vertical alignment nematic liquid crystal layer;
an analyzer, disposed after the liquid crystal panel and on the path of the light; and
a projection lens, disposed after the analyzer and on the path of the light.

14. The liquid crystal projection device of claim 13, further comprising:
a micro color filter array, comprising a plurality of micro color filters and disposed on another surface of the first substrate.

15. The liquid crystal projection device of claim 14, wherein the micro color filters comprise dichroic micro color filters.

16. The liquid crystal projection device of claim 14, wherein a material of the micro color filter array comprises an inorganic material.

17. The liquid crystal projection device of claim 14, wherein the micro color filters have a round shape.

18. The liquid crystal projection device of claim 14, wherein the micro color filters have a rounded rectangular shape.

19. The liquid crystal projection device of claim 13, further comprising:
a plurality of protrusions, disposed on the first transparent electrode layer and/or the second electrode layer for aligning the liquid crystal molecules.

20. The liquid crystal projection device of claim 13, wherein the liquid crystal panel comprises a single-panel liquid crystal panel.

21. The liquid crystal projection device of claim 13, wherein a pixel of the single-panel liquid crystal panel comprise a plurality of color sub-pixels.

22. The liquid crystal projection device of claim 21, wherein the color sub-pixels comprise red, green and blue pixels.

23. The liquid crystal projection device of claim 21, wherein the color sub-pixels comprise red, green, blue and white pixels.

24. The liquid crystal projection device of claim 13, further comprising:
a polarization conversion system, disposed on the path of the light and between the light source and the polarizer.

25. The liquid crystal projection device of claim 13, further comprising:
a lens disposed on the path of the light and between the light source and the polarizer.

26. The liquid crystal projection device of claim 13, wherein a material of the first substrate or the second substrate comprises quartz.
